(19) United States
(12) Patent Application Publication
(10) Pub. No.: US 2008/0013568 A1
(43) Pub. Date: Jan. 17, 2008

(54) Apparatus, Method and Computer Program Product for a Network Node Engine

(76) Inventors: John James Poetker, Mt. Airy, MD (US); Michael Bruce Folkart, Rockville, MD (US); Jeffrey Allen Jones, Ijamsvile, MD (US); Jerry Leroy Shumway, Rockville, MD (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/774,117

(22) Filed: Jul. 6, 2007

Related U.S. Application Data
(63) Continuation-in-part of application No. 11/281,882, filed on Nov. 18, 2005.
(60) Provisional application No. 60/629,331, filed on Nov. 19, 2004.

(51) Int. Cl. H04J 3/22

(52) U.S. Cl. 370/465

(57) ABSTRACT

An apparatus for a network node includes a programmable network node. The programmable network node includes a programmable signal processing element, and a processor. The processor may be configured to communicate with one or more networks and at least one device configured to communicate in a format different from the format of the one or more networks at least in part via the programmable signal processing element. The programmable signal processing element may be configured to process data communicated between the network node and the one or more networks and the at least one device based on programming received at the programmable signal processing element.

### CROSS REFERENCE TO RELATED APPLICATION

This application is a continuation-in-part of copending U.S. patent application Ser. No. 11/281,882, entitled “Real-Time Packet Processing System and Method” filed Nov. 18, 2005, which claims priority to Provisional Patent Application No. 60/629,331, filed on Nov. 19, 2004, both of which are incorporated herein by reference in their entirety.

### FIELD OF THE INVENTION

Embodiments of the present invention relate generally to communication systems, and more particularly, to a network node engine.

### BACKGROUND OF THE INVENTION

In the modern world, wireless communications are being integrated into activities of all kinds due to the increasing availability and popularity of wireless communication devices coupled with the mobility of such devices. For example, electronic devices capable of communicating voice content, media, data, etc. are now commonly carried by individuals or are fixtures in vehicles and homes. Numerous networks have been developed to support information exchange using electronic devices having widely varying capabilities and/or purposes.

Many businesses, public service organizations, military organizations and other groups have enhanced or developed areas of their respective operations using communication devices. For example, a small group or even a large fleet of units such as vehicles may be equipped with communication devices which enhance the effectiveness of the group or fleet by enabling the coordination of efforts of the members of the group or fleet. Examples of such groups may include police and rescue vehicles, transportation vehicles, fishing fleets, military convoys, squadrons or combat teams.

Additionally, current technological developments continue to expand upon the types and capabilities of electronic devices that can enhance the effectiveness of an organization's operations. For example, a variety of electronic devices such as complex electronic sensors, computing systems, devices offering internet access, guidance and navigation systems or other equipment may be incorporated into a platform to enhance the capabilities of the platform. While the addition of communications equipment and other electronic devices certainly improves the ability of each platform, a disadvantage of such additions is that devices of varying ages and types may be placed in communication with each other, thereby requiring corresponding translators or interfaces to enable communication between such devices. For example, each electronic device or piece of equipment may have different protocols, encryption/decryption services, or other unique characteristics, which require unique interface requirements in order to integrate into one system or network.

Accordingly, it may be desirable to introduce a device that is capable of overcoming at least some of the disadvantages described above.

### BRIEF SUMMARY OF THE INVENTION

A programmable network node is provided that may act as an intelligent processing node, for example, in an Ethernet network. Accordingly, a need for network interface cards (NICs) and associated computers to establish network connections for a user application may be reduced. Accordingly, dissimilar networks and devices may be in communication with each other via the programmable network node.

In one exemplary embodiment, a programmable network node is provided. The programmable network node includes a programmable signal processing element, and a processor. The processor may be configured to communicate with one or more networks and at least one device configured to communicate in a format different from the format of the one or more networks at least in part via the programmable signal processing element. The programmable signal processing element may be configured to process data communicated between the network node and the one or more networks and the at least one device based on programming received at the programmable signal processing element.

In other exemplary embodiments, a method and computer program product for providing a programmable network node are provided. The method and computer program product include operations or executable portions for receiving programming regarding processing data communicated between a network node and one or more networks and at least one device configured to communicate in a format different from the format of the one or more networks, for receiving a data packet in a first format from one of the one or more networks or the at least one device, and for processing the received data packet based on the received programming.

Embodiments of the invention provide a programmable network node that may be embodied in a compact and programmable platform that may act as an intelligent node capable of being programmed to whatever application or service a user desires. As such, embodiments of the present invention may be useful in a number of different types of units. In this regard, a unit as referred to hereinafter should be considered, without limitation, to include vehicles, aircraft, water craft, offices, homes, boardrooms, mobile or fixed communication centers, etc. Accordingly, a system is provided in which a combination of hardware and software may provide a platform which, due to its physical size and computer processing capability may be used as an intelligent processing node on Ethernet networks. The platform may reduce requirements for NICs and associated computers to establish network connections for a user application. The platform may also provide encryption/de-encryption services and media conversion such as VoIP for such user applications. The platform may also be utilized to adapt analog and digital data streams to Ethernet networks. The features of the platform may be achieved by combining the capabilities of, for example, field programmable arrays (FPGA), reduced instruction set processors (RISC) and digital signal processors (DSP) with requisite Ethernet physical and media access devices to form a programmable platform.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a diagram illustrating a system according to an exemplary embodiment of the present invention;

FIG. 2 illustrates a block diagram of a programmable network node according to an exemplary embodiment of the present invention; and

FIG. 3 shows a flowchart of a method for establishing an intelligent network node according to an exemplary embodiment of the present invention.

### DETAILED DESCRIPTION OF THE INVENTION

Embodiments of the present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like reference numerals refer to like elements throughout.

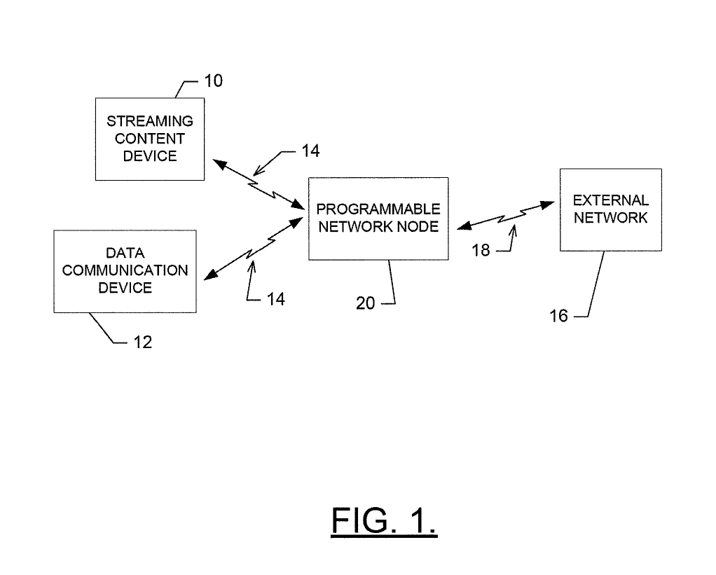

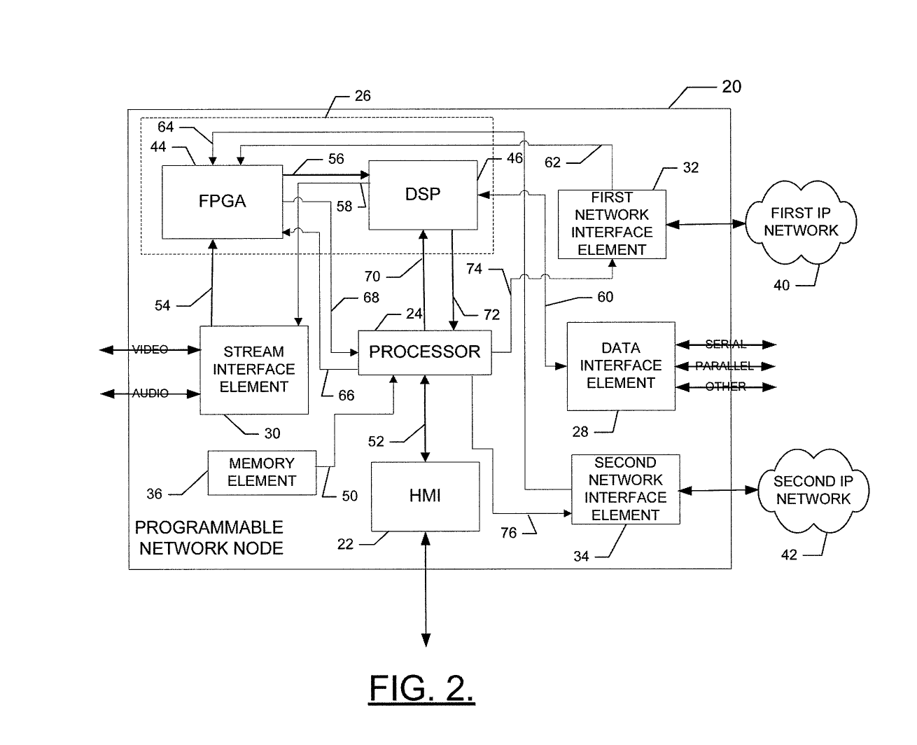

FIG. 1 is a diagram illustrating a system according to an exemplary embodiment of the present invention. It should be noted initially and throughout the description to follow that although FIGS. 1 and 2 illustrate configurations for embodiments of the present invention, embodiments of the present invention may also utilize other configurations as well. In this regard, FIGS. 1 and 2 are merely provided for purposes of example and not of limitation.

Referring now to FIG. 1, one or more non-IP (Internet Protocol) devices including, for example, a content streaming device 10 such as an audio or video streaming device and a data communication device 12 configured to send and/or receive data or messages (e.g., a sensor, GPS receiver, etc.) may be in communication with a programmable network node 20 via first communication links 14. One or more external networks 16 may also be in communication with the programmable network node 20 via second communication links 18. The first and second communication links 14 and 18 may be established via, for example, a wired or wireless communication standard. In an exemplary embodiment, the first and second communication links 14 and 18 may include different types of communication links. In this regard, any suitable communication link may be employed such as, for example, wireless local area networks (WLANs), Bluetooth, cellular networks, IP radio frequency (RF) networks or publicly switched telephone networks. In an exemplary embodiment, the one or more external networks 16 may be IP networks, although other types of networks are possible. Thus, according to this example, the non-IP devices may be integrated into the IP networks using the programmable network node 20.

FIG. 2 illustrates a block diagram of the programmable network node 20 according to an exemplary embodiment. The programmable network node 20 may be any means or device embodied in hardware, software or a combination of hardware and software that is configured to perform the corresponding functions of the programmable network node 20 as described below. The programmable network node 20 may include a human to machine interface (HMI) 22, a processor 24, a programmable signal processing element 26, a data interface element 28, a stream interface element 30, a first network interface 32, a second network interface 34 and a memory element 36. Accordingly, the programmable network node 20 may include a plurality of processing elements and interface devices to enable the communication of several different devices and/or types of devices with dissimilar networks.

The HMI 22 may be any HMI known in the art and is typically capable of providing operator input or control to the processor 24 for such operations as, for example, mode selection, channel selection, tuning operations, input of addresses from which communications should be monitored, etc. As such, the HMI may be any device or means embodied in either hardware, software, or a combination of hardware and software that is capable of accepting operator input for control of communication between the programmable network node 20 and external devices and/or networks. The HMI 22 may also be capable of providing user output in the form of audio, video, data, etc. As such, the HMI 22 may include one or more of a speaker, a display, or any other output mechanism.

The processor 24 may be any typical processing element. A processing element such as those described herein may be embodied in many ways. For example, the processing element may be embodied as a processor, a coprocessor, a controller (including e.g., a RISC) or various other processing means or devices including integrated circuits such as, for example, an ASIC (application specific integrated circuit). In this example, the processor 24 communicates with the programmable signal processing element 26, the HMI 22, the memory element 36 and the first and second network interfaces 32 and 34 in order to facilitate communications between one or more dissimilar networks and/or devices to perform a particular application and/or service. In this regard, for example, the processor 24 may communicate with elements of the programmable network node 20 to distribute packet data to various other respective elements of the programmable network node 20 depending upon, for example, the programming of the programmable signal processing element 26. In an exemplary embodiment, the programming of the programmable signal processing element 26 may be determined by the HMI 22 such as, for example, by selection of a mode of operation or by other input.

The memory element 36 may include, for example, volatile and/or non-volatile memory. The memory element 36 may be configured to store information, data, applications, instructions or the like for enabling the programmable network node 20 to carry out various functions in accordance with exemplary embodiments of the present invention. For example, the memory element 36 could be configured to buffer input data for processing by the processor 24. Additionally or alternatively, the memory element 36 could be configured to store other data including, for example, a particular user application.

In an exemplary embodiment, the programmable network node 20 may be configured as an intelligent network node. In this regard, the programmable network node 20 may be configured or programmed to provide a network interface and host a particular user application. As stated above, the particular user application may be stored, for example, in the memory element 36 and may be uploaded to the processor 24 upon the application of power to the programmable network node 20.

In an exemplary embodiment, the processor 24 may host dual TCP (transmission control protocol)/IP software stacks and/or Ethernet drivers suitable to support one or more independent network interfaces (e.g., the first and second network interfaces 32 and 34). The one or more independent network interfaces may provide an interface between the programmable network node 20 and one or more corresponding external networks. In this regard, each of the first and second network interfaces 32 and 34 may be any device or means embodied in either hardware, software, or a combination of hardware and software that is capable of providing an interface between an external network (e.g., an IP network) and the programmable network node 20. In this exemplary embodiment, the first and second network interfaces 32 and 34 may be in communication with a first IP network 40 and a second IP network 42, respectively. The first and second network interfaces 32 and 34 may each be in communication with a media access control (MAC) layer and a physical layer interface between the programmable network node 20 and the respective first and second IP networks 40 and 42. Accordingly, the first and second network interfaces 32 and 34 may communicate incoming IP packets to the programmable signal processing element 26 for processing. Additionally, the first and second network interfaces 32 and 34 may receive outgoing IP packets from the processor 24.

The programmable signal processing element 26 may be in communication with the processor 24, the first and second network interfaces 32 and 34, the data interface element 28 and the stream interface element 30 for processing data received from or sent to each of the corresponding above listed elements. As such, the programmable signal processing element 26 may be any device or means embodied in either hardware, software, or a combination of hardware and software that is capable of receiving programming for use with a particular application and/or service and, responsive to the programming received, providing signal processing and interface functions to enable communication between various networks and/or devices. In an exemplary embodiment, the programmable signal processing element 26 may include a field programmable gate array (FPGA) 44 and a digital signal processor (DSP) 46. The FPGA 44 and the DSP 46 may each be any device or means embodied in either hardware, software, or a combination of hardware and software that is capable of performing the corresponding functions associated with the FPGA 44 and the DSP 46, respectively, as described below.

The FPGA 44 may be any FPGA known in the art. In an exemplary embodiment, the FPGA 44 may be in communication with the processor 24, the DSP 46, the stream interface element 30 and the first and second network interfaces 32 and 34. The FPGA 44 may be configured to receive, for example, packet data from either of the first and second network interfaces 32 and 34 and perform real-time packet filtering and processing of the received packet data. In this regard, the FPGA 44 may reduce the processing requirements that would otherwise fall to the processor 24. The processor 24 may communicate network configuration data and/or filtering data to the FPGA 44 for use by the FPGA 44 in processing or filtering received packet data. As such, based on the configuration and/or filtering data received from the processor 24, the FPGA 44 may route incoming packets from either or both of the first and second network interfaces 32 and 34 to the processor after processing or filtering the incoming packets. In an exemplary embodiment, the FPGA 44 may route streaming or RTP packets such as audio (e.g., voice over IP (VoIP) data) or video (e.g., JPEG/MPEG) received from the stream interface element 30.

The DSP 46 may be configured to function as a translation element providing translation between packet data of dissimilar networks and/or devices communicating data in various formats or protocols. Meanwhile, in one embodiment, the FPGA 44 may function as a routing element that dynamically updates packet data routing based on the content of the packet data and filters packet data according to instructions from the processor 24. The DSP 46 may process each packet differently according to the particular type of packet. Accordingly, speech packets may be processed through a respective speech decoder and other types of data which may require encryption may receive encryption/de-encryption services via the DSP 46 according to instructions that may correspond, for example, to the particular application being executed

The DSP 46 may be configured to decompress, modify and/or recompress packet data payloads from various networks or devices for transmission over the other networks or to other devices via the processor 24. In other words, the DSP 46 provides the translation of data from dissimilar networks or devices so that, regardless of the network or device of origination, data packets may be processed and translated at the DSP 46 into a format suitable for transmission via a corresponding interface. For example, the DSP 46 may receive incoming audio packets from the stream interface element 30 and convert the audio packets into, for example, real time transfer protocol (RTP) packets. A further discussion of the capabilities of the programmable network node 20, and in particular the DSP for use with RTP packet handling, may be found in U.S. patent application Ser. No. 11/281,882, entitled “Real-Time Packet Processing System and Method” filed Nov. 18, 2005, which claims priority to Provisional Patent Application No. 60/629,331, filed on Nov. 19, 2004, both of which are incorporated herein by reference in their entirety.

The data interface element 28 and the stream interface element 30 may each be any device or means embodied in either hardware, software, or a combination of hardware and software that is capable of interfacing with various assets or devices of an internal or local network of a corresponding unit in which the programmable network node 20 is disposed. In this regard, the data interface element 28 may function as a converter for converting incoming data into digital data for payload placement in the DSP 46 and converting outgoing data into a digital format that is suitable for use at a corresponding asset or device which may act as an output device. The data interface element 28 may be configured to receive data in many protocol formats from many corresponding types of devices. In this regard, for example, the data interface element 28 may be capable of communication with serial, parallel or other types of formatted data such as, for example, a serial peripheral interface (e.g., Motorola SPI), Integrated Inter-Processor Communications (e.g., Philips I²C), IEEE standard serial interfaces such as RS232C and RS455/485, or industry standards such as the peripheral component interconnect (PCI) bus. Regardless of the format of data received at the data interface element 28, the programmable signal processing element 26 may be configured (e.g., via the DSP 46) to support data conversions for incoming and/or outgoing data from the various forms of digital data input into a data format suitable for communication with other elements of the programmable network node 20 and/or other devices via any of the interfaces of the programmable network node 20 with other networks and/or devices.

The stream interface element 30 may include analog to digital and/or digital to analog converters and/or compression and decompression devices or codecs for performing conversion and compression/decompression for incoming and outgoing data. Accordingly, the stream interface element 30 may be configured to communicate with various devices capable of providing, for example, streamed data as an input or receiving streamed data as an output. In this regard, the stream interface element 30 may convert incoming audio and/or video signals into a digital format. Meanwhile, outgoing audio data may be decompressed and/or converted to analog data for output to a speaker or other output device. It should be noted that, as used above, the term incoming refers to data that is coming into the programmable network node 20 via any of the first and second network interfaces 32 and 34, the data interface element 28 or the stream interface element 30, while the term outgoing refers to data that is leaving the programmable network node 20 via any of the first and second network interfaces 32 and 34, the data interface element 28 or the stream interface element 30.

In operation according to one exemplary embodiment, at power up the processor 24 may load the particular application from the memory element 36 as indicated by line 50. The HMI 22 may communicate with the processor 24 as indicated by line 52 to provide user input or provide an output to the user. Incoming data may be received at the stream interface element 30, the data interface element 28, the first network interface 32 and/or the second network interface 34. Incoming data in the form, for example, of audio or video data to the stream interface element 30 may be communicated to the FPGA 44 as indicated by line 54. Such streaming data or RTP packets from the stream interface element 30 may then be communicated to the DSP 46 as indicated at line 56 for decomposition into data suitable for output via the stream interface element 30 as indicated by line 58 or the data interface element 28 as indicated by line 60. Meanwhile, incoming data from the first IP network 40 and/or the second IP network 42 may be communicated to the FPGA 44 by the first and second network interface elements 32 and 34, respectively, as indicated by respective lines 62 and 64 for real-time packet filtering and/or processing. The FPGA 44 may receive network configuration and filtering data from the processor 24 as indicated by line 66. The FPGA 44 may then communicate received incoming IP packets from either network to the processor 24 as indicated by line 68.

The processor 24 may also provide channeling, configuration and data format information to the DSP 46 as indicated by line 70. The DSP 46 may route packets ready for network transmission to the processor 24 as indicated by line 72. The processor 24 may then input such packets into a TCP/IP stack transmission queue for transmission to the first and second IP networks 40 and 42 via the first and second network interfaces 32 and 34, respectively, as indicated by respective lines 74 and 76.

Accordingly, the programmable network node 20 may be used to create a programmable user node on a network wherein the network interface becomes an intelligent node that may be programmed to perform whatever application or service the user desires. As such, embodiments of the present invention may provide multi-channel media conversion in order to convert digital and/or analog data into data suitable for Ethernet IP transport to enable the connection of existing or legacy non-IP devices to networked systems. Embodiments may also support multiple data channel encryption and de-encryption services for secure network connections. Thus, encryption and de-encryption services may be integrated into every network node to thereby enhance distribution of secure information. Embodiments also provide a programmable application host in order to provide open systems RTOS and TCP/IP stacks to support software defined applications. In this regard, the programmable network node 20 may be configured to enable individual programming of each network node for performance of a specific task such as network management, communications portal activity, sensor connection, telephony functions, remote control, gateway functions, network bridge functions, router services and other user requirements.

Exemplary embodiments may also provide redundant Ethernet nodes that support two independent networks and allow the networks to be dissimilar and bridged. In this regard, it should be noted that although the first and second networks 32 and 34 are described as being IP networks, other types of networks could also be supported. Accordingly, each node may support two independent networks to provide fail-over redundancy, secure and non-secure networks and dissimilar network bridging. Exemplary embodiments may also provide for peripheral devices using different media types such as digital (serial and parallel), analog, PCI, SPI, I²C, etc., to be networked via multiple interface types. Thus, the programmable network node 20 may be connected to multiple existing or legacy devices or may be attached to various components or systems without requiring modification of those systems in order for such systems to become part of a distributed IP network.

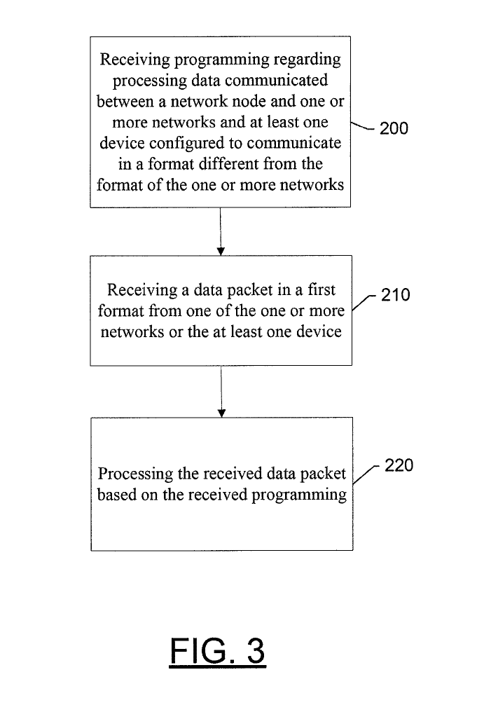

FIG. 3 is a flowchart of a system, method and program product according to exemplary embodiments of the invention. It will be understood that each block or step of the flowcharts, and combinations of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of the network node and executed by a built-in processor in the network node. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

As shown in FIG. 3 a method for establishing an intelligent network node may include receiving programming regarding processing data communicated between a network node and one or more networks and at least one device configured to communicate in a format different from the format of the one or more networks at operation 200. In an exemplary embodiment, operation 200 may include receiving programming for translation of data between dissimilar devices and networks based on an application executed at the network node or a service provided by the network node. At operation 210, a data packet may be received in a first format from one of the one or more networks or the at least one device. In an exemplary embodiment, operation 210 may include receiving Internet protocol (IP) data from a first IP network and a second IP network. In this regard, a non-IP data packet may be received via a data interface element configured to communicate via at least two of a serial interface, parallel interface, serial peripheral interface, integrated inter-processor communications interface or peripheral component interconnect bus interface. Alternatively or additionally, non-IP data may be received via a streaming interface element configured to interface with a non-IP device comprising a device configured to deliver or receive streaming content. The received data packet may then be processed based on the received programming at operation 220. In an exemplary embodiment, operation 220 may include processing the received data packet using a field programmable gate array (FPGA) and a digital signal processor (DSP) in communication with each other. In this regard, the FPGA may be configured for routing packet data and filtering packet data according to instructions received from a processor in communication with the FPGA. The DSP may be configured for translating data communicated between the network node and the one or more networks and the at least one device in which the data communicated comprises packet data of dissimilar networks or of devices communicating data in different formats. The method may therefore include performing multi-channel media conversion between digital or analog data and data suitable for Internet protocol (IP) transport.

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. For example, while embodiments of the invention may be described in terms of establishing an intercom system between vehicles, other embodiments may establish an intercom system between other units or offices, boardrooms, etc. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A network node comprising:
a programmable signal processing element; and
a processor configured to communicate with one or more networks and at least one device configured to communicate in a format different from the format of the one or more networks at least in part via the programmable signal processing element,
wherein the programmable signal processing element is configured to process data communicated between the network node and the one or more networks and the at least one device based on programming received at the programmable signal processing element.

2. The network node of claim 1, wherein the programmable signal processing element is further configured to receive programming for translation of data between dissimilar devices and networks based on an application executed at the network node.

3. The network node of claim 1, wherein the programmable signal processing element is further configured to receive programming for translation of data between dissimilar devices and networks based on a service provided by the network node.

4. The network node of claim 1, wherein the one or more networks include a first Internet protocol (IP) network and a second IP network and the at least one device comprises a non-IP device.

5. The network node of claim 4, further comprising a data interface element configured to interface with the non-IP device via an interface comprising at least two of a serial interface, parallel interface, serial peripheral interface, integrated inter-processor communications interface or peripheral component interconnect bus interface.

6. The network node of claim 4, further comprising a streaming interface element configured to interface with the non-IP device comprising a device configured to deliver or receive streaming content.

7. The network node of claim 1, wherein the programmable signal processing element comprises a field programmable gate array (FPGA) and a digital signal processor (DSP) in communication with each other.

8. The network node of claim 7, wherein the FPGA is configured to route packet data and filter packet data according to instructions from the processor.

9. The network node of claim 7, wherein the DSP is configured to translate data communicated between the network node and the one or more networks and the at least one device in which the data communicated comprises packet data of dissimilar networks or of devices communicating data in different formats.

10. The network node of claim 1, wherein the network node is configured to perform multi-channel media conversion between digital or analog data and data suitable for Internet protocol (IP) transport.

11. A method of communicating data in a network node, the method comprising:
receiving programming regarding processing data communicated between a network node and one or more networks and at least one device configured to communicate in a format different from the format of the one or more networks;
receiving a data packet in a first format from one of the one or more networks or the at least one device; and
processing the received data packet based on the received programming.

12. The method of claim 11, wherein receiving programming further comprises receiving programming for translation of data between dissimilar devices and networks based on an application executed at the network node.

13. The method of claim 11, wherein receiving programming further comprises receiving programming for translation of data between dissimilar devices and networks based on a service provided by the network node.

14. The method of claim 11, wherein receiving the data packet comprises receiving Internet protocol (IP) data from a first IP network and a second IP network.

15. The method of claim 11, wherein receiving the data packet comprises receiving non-Internet protocol (IP) data via a data interface element configured to communicate via at least two of a serial interface, parallel interface, serial peripheral interface, integrated inter-processor communications interface or peripheral component interconnect bus interface.

16. The method of claim 11, wherein receiving the data packet comprises receiving non-Internet protocol (IP) data via a streaming interface element configured to interface with a non-IP device comprising a device configured to deliver or receive streaming content.

17. The method of claim 11, wherein processing the received data packet based on the received programming comprises processing the received data packet using a field programmable gate array (FPGA) and a digital signal processor (DSP) in communication with each other.

18. The method of claim 17, wherein processing the received data packet based on the received programming comprises routing packet data and filtering packet data according to instructions received from a processor in communication with the FPGA.

19. The method of claim 17, wherein processing the received data packet based on the received programming comprises translating data communicated between the network node and the one or more networks and the at least one device in which the data communicated comprises packet data of dissimilar networks or of devices communicating data in different formats.

20. The method of claim 11, further comprising performing multi-channel media conversion between digital or analog data and data suitable for Internet protocol (IP) transport.

21. A computer program product for communicating data in a network node, the computer program product comprising at least one computer-readable storage medium having computer-readable program code portions stored therein, the computer-readable program code portions comprising:
a first executable portion for receiving programming regarding processing data communicated between a network node and one or more networks and at least one device configured to communicate in a format different from the format of the one or more networks;
a second executable portion for receiving a data packet in a first format from one of the one or more networks or the at least one device; and
a third executable portion for processing the received data packet based on the received programming.

22. The computer program product of claim 21, wherein the first executable portion includes instructions for receiving programming further comprises receiving programming for translation of data between dissimilar devices and networks based on an application executed at the network node.

23. The computer program product of claim 21, wherein the first executable portion includes instructions for receiving programming for translation of data between dissimilar devices and networks based on a service provided by the network node.

24. The computer program product of claim 21, wherein the second executable portion includes instructions for receiving Internet protocol (IP) data from a first IP network and a second IP network.

25. The computer program product of claim 21, wherein the second executable portion includes instructions for receiving non-Internet protocol (IP) data via a data interface element configured to communicate via at least two of a serial interface, parallel interface, serial peripheral interface, integrated inter-processor communications interface or peripheral component interconnect bus interface.

26. The computer program product of claim 21, wherein the second executable portion includes instructions for receiving non-Internet protocol (IP) data via a streaming interface element configured to interface with a non-IP device comprising a device configured to deliver or receive streaming content.

27. The computer program product of claim 21, wherein the third executable portion includes instructions for processing the received data packet using a field programmable gate array (FPGA) and a digital signal processor (DSP) in communication with each other.

28. The computer program product of claim 27, wherein the third executable portion includes instructions for routing packet data and filtering packet data according to instructions received from a processor in communication with the FPGA.

29. The computer program product of claim 27, wherein the third executable portion includes instructions for translating data communicated between the network node and the one or more networks and the at least one device in which the data communicated comprises packet data of dissimilar networks or of devices communicating data in different formats.

30. The computer program product of claim 21, further comprising a fourth executable portion for performing multi-channel media conversion between digital or analog data and data suitable for Internet protocol (IP) transport.
